(19) United States
(12) Patent Application Publication
(10) Pub. No.: US 2025/0348239 A1
(43) Pub. Date: Nov. 13, 2025

(54) MEMORY MANAGEMENT METHOD, STORAGE MEDIUM, AND ELECTRONIC DEVICE

(71) Applicant: MONTAGE TECHNOLOGY CO., LTD., Shanghai (CN)

(72) Inventors: Longfei TAI, Shanghai (CN); Ming LI, Shanghai (CN); Qian WU, Shanghai (CN)

(73) Assignee: MONTAGE TECHNOLOGY CO., LTD., Shanghai (CN)

(21) Appl. No.: 19/093,293

(22) Filed: Mar. 28, 2025

(30) Foreign Application Priority Data
May 7, 2024 (CN) 2024105591891

(51) Int. Cl. G06F 3/06

(52) U.S. Cl. CPC G06F 3/0631; G06F 3/0608; G06F 3/064; G06F 3/0679

(57) ABSTRACT

A memory management method, a storage medium, and an electronic device are provided. The method includes steps S21-S23. Step S21 includes obtaining, based on an execution sequence of operators in a network computation graph, a data stream sequence corresponding to the operators during operation, and constructing a memory demand sequence corresponding to the data stream sequence. Step S22 includes creating a target memory block in available memory spaces of a first memory. Step S23 includes allocating a memory space for each of memory demands in the memory demand sequence based on a sequencing number and a life cycle of each of the memory demands and a size of the target memory block. The presently disclosed method enhances memory utilization efficiency.

### FIELD OF THE INVENTION

The present disclosure belongs to the field of computer technologies, and relates to memory management, and in particular, to a memory management method, a storage medium, and an electronic device.

### BACKGROUND OF THE INVENTION

Memories are vital components of electronic products. Efficiently managing and optimizing memory space is essential for maximizing the utilization of memory space, reducing costs, and boosting hardware performance. For chips that process large amounts of data, like artificial intelligence (AI) chips, effectively and efficiently managing their limited memory space is crucial.

Memory management generally includes static memory management and dynamic memory management. In static memory management, memory is allocated during the compilation stage, making it more advantageous for applications with high-performance and relatively stable memory requirements. However, existing static memory management methods often cause memory fragmentation during use, which reduces memory utilization efficiency.

Consequently, it is essential to develop a memory management method that can improve memory utilization efficiency.

### SUMMARY OF THE INVENTION

Embodiments of the present disclosure provide a memory management method, a storage medium, and an electronic device, which reduce memory fragmentation and improve memory utilization.

A first embodiment of the present disclosure provides a memory management method, comprising steps S21-S23. Step S21 comprises: obtaining, based on an execution sequence of operators in a network computation graph, a data stream sequence corresponding to the operators during operation, and constructing a memory demand sequence corresponding to the data stream sequence. Step S22 comprises: creating a target memory block in available memory spaces of a first memory. Step S23 comprises: allocating a memory space for each of memory demands in the memory demand sequence based on a sequencing number and a life cycle of each of the memory demands and a size of the target memory block.

In some examples of the present disclosure, step S21 is performed by: obtaining the data stream sequence based on the execution sequence of the operators, and based on input data, parameters and output data of each of the operators during operation; and determining a memory demand of each data in the data stream sequence based on data size, and forming the memory demand sequence based on the memory demand of each data.

In some examples of the present disclosure, the sequencing number of each of the memory demands in the memory demand sequence is determined based on a sequencing number of data in the data stream sequence corresponding to each memory demand.

In some examples of the present disclosure, step S23 is performed by: determining and recording, based on the sequencing number of each of the memory demands in the memory demand sequence, first M memory demands in the memory demand sequence that are able to be simultaneously satisfied by the target memory block, wherein M is an integer less than or equal to N, and N represents a total quantity of the memory demands in the memory demand sequence; and determining whether M is equal to 0, and if not, obtaining the life cycle of each of the first M memory demands, and allocating a memory space for each of the first M memory demands from the target memory block based on the life cycle of each of the first M memory demands.

In some examples of the present disclosure, the first M memory demands in the memory demand sequence that are able to be simultaneously satisfied by the target memory block are determined by: step a: denoting a size of a memory space required by a kth memory demand among the memory demand sequence as memory_k_size, and determining whether memory_k_size is less than or equal to a reference comparison value denoted as block_ref_size, where k is a positive integer, initially set to one, and an initial value of the reference comparison value is equal to the size of the target memory block, if yes, proceeding to step b, and if not, proceeding to step d; step b: recording the kth memory demand, and updating the reference comparison value to be block_ref_size-memory_k_size; step c: increasing k by 1, and determining whether k is greater than N, if yes, ending the process, and if not, returning to step a, until k is greater than N or memory_k_size is greater than block_ref_size; step d: determining M as (k−1).

In some examples of the present disclosure, obtaining the life cycle of each of the first M memory demands is performed by: obtaining the life cycle of each of the first M memory demands based on a dependency relationship between the data corresponding to the memory demands and the sequencing number of each of the memory demands.

In some examples of the present disclosure, allocating a memory space for each of the first M memory demands from the target memory block based on the life cycle of each of the first M memory demands is performed by: allocating, based on a descending order of life cycles of the first M memory demands, a memory space for each of the first M memory demands along a direction from a first boundary of the target memory block to a second boundary of the target memory block.

In some examples of the present disclosure, after allocating a memory space for each of the first M memory demands from the target memory block, the memory management method further comprises: recreating the target memory block when the memory demand sequence comprises a memory demand to whom a memory space is yet to be allocated or a new memory demand sequence is generated.

In some examples of the present disclosure, when M is equal to 0, the memory management method further comprises: allocating a memory space for a first memory demand among the memory demand sequence based on a preset strategy.

In some examples of the present disclosure, the preset strategy comprises one or more of reusing the memory spaces, reordering the memory spaces that have been allocated, transferring and releasing part of the memory spaces that have been allocated, and splitting the operators.

In some examples of the present disclosure, allocating a memory space for the first memory demand by reusing the memory spaces comprises: searching for a first operator in the operators corresponding to the first memory demand, wherein the first memory demand corresponds to output data of the first operator, and a memory space has been allocated to input data of the first operator; and when the first operator is found, reusing the memory space allocated to the input data of the first operator for the first memory demand.

In some examples of the present disclosure, allocating a memory space for the first memory demand by reordering the memory spaces that have been allocated comprises: determining whether a sum of the available memory spaces of the first memory satisfies the first memory demand, if yes, configuring a memory transferring module to sequentially and continuously arrange the memory spaces that have been allocated from a starting address or an ending address of the first memory, and allocating a memory space for the first memory demand from the remaining available memory spaces of the first memory after the arranging of the memory spaces that have been allocated is completed.

In some examples of the present disclosure, allocating a memory space for the first memory demand by transferring and releasing part of the memory spaces that have been allocated comprises: searching for a second operator in the operators corresponding to the first memory demand, where the second operator is the first one found in an undefined state, and the undefined state indicates that none of the memory demands corresponding to the second operator have been allocated a memory space; searching, from the memory demands corresponding to the memory spaces that have been allocated, memory demands that do not have a corresponding relationship with the second operator, and recording the memory demands; selecting part of the recorded memory demands and transferring storage data in the memory spaces corresponding to the selected memory demands to a second memory for memory space releasing, wherein the memory spaces corresponding to the selected memory demands and the available memory spaces in the first memory form an available continuous memory space, and the available continuous memory space is greater than or equal to the memory space required by the first memory demand; and allocating a memory space for the first memory demand from the available continuous memory space.

In some examples of the present disclosure, allocating a memory space for the first memory demand by splitting the operators comprises: searching for a third operator in the operators corresponding to the first memory demand and splitting the third operator, wherein the first memory demand corresponds to data of the third operator other than input data; and after searching for and splitting the third operator, determining whether a sum of the available memory spaces of the first memory satisfies the first memory demand, and if yes, reconstructing the memory demand sequence and allocating a memory space for the first memory demand.

In some examples of the present disclosure, the network computation graph is a directed acyclic graph.

In some examples of the present disclosure, the target memory block is a continuous memory space in the available memory spaces of the first memory.

A second embodiment of the present disclosure provides a non-transitory computer-readable storage medium, which stores a computer program, and a memory management method as described in the examples of the first embodiment of the present disclosure is implemented when the computer program is executed by a processor.

A third embodiment of the present disclosure provides an electronic device, comprising a memory and a processor. A computer program is stored on the memory. The processor is communicatively connected to the memory and configured to call the computer program to perform a memory management method as described in the examples of the first embodiment of the present disclosure.

The presently disclosed memory management method allocates a memory space for each of memory demands in the memory demand sequence based on a sequencing number and a life cycle of each of the memory demands and a size of the target memory block, reducing memory fragmentation and improving memory utilization efficiency.

### BRIEF DESCRIPTION OF DRAWINGS

FIG. 1 shows a schematic diagram of an application scenario of a memory management method according to an embodiment of the present disclosure.

FIG. 2A shows a flowchart of the memory management method according to an embodiment of the present disclosure.

FIG. 2B shows a detailed flowchart of step S21 in FIG. 2A.

FIG. 2C shows a schematic diagram of a network computation graph according to an embodiment of the present disclosure.

FIG. 3 shows a detailed flowchart of step S23 in FIG. 2A.

FIG. 4 shows a schematic diagram of allocating and releasing memory spaces according to an embodiment of the present disclosure.

FIG. 5 shows a schematic diagram of reordering the memory spaces according to an embodiment of the present disclosure.

FIG. 6 shows a flowchart of allocating a memory space for a first memory demand by transferring and releasing part of the memory spaces that have been allocated according to an embodiment of the present disclosure.

### DETAILED DESCRIPTION OF THE INVENTION

The embodiments of the present disclosure will be described below. Those skilled can easily understand other advantages and effects of the present disclosure according to contents disclosed by the specification. The present disclosure can also be implemented or applied through other different specific embodiments. Various details in this specification can also be modified or changed based on different viewpoints and disclosures without departing from the spirit of the present disclosure. It should be noted that the following embodiments and features of the following embodiments can be combined with each other if no conflict will result.

It should be noted that the drawings provided in this disclosure only illustrate the basic concept of the present disclosure in a schematic way, so the drawings only show the components closely related to the present disclosure. The drawings are not necessarily drawn according to the number, shape and size of the components in actual implementation; during the actual implementation, the type, quantity and proportion of each component can be changed as needed, and the layout of the components can also be more complicated.

In the design and optimization of chips that require extensive data computation, efficiently managing memory resources (such as Double Data Rate (DDR) and Static Random Access Memory (SRAM)) can reduce costs. For example, in AI chips, efficient SRAM management can enhance the reuse of internal memory, thereby reducing the bandwidth required for network inference. By lowering the bandwidth, the stability of model inference time can be improved, reducing issues caused by bandwidth competition. Additionally, it helps alleviate bandwidth bottlenecks and improves operator execution speed. However, existing memory management algorithms often lead to memory fragmentation, increased communication overhead, and suboptimal performance. For instance, exchanging unused data from the memory space of the current computing device to another memory space and then exchanging it back during the next access may incur communication and synchronization overhead.

To address these issues, the present disclosure presents a memory management method. The memory management method can be applied to various electronic devices, such as those with AI chips. This memory management method can also be applied to smart terminals, embedded systems, cloud servers, and more.

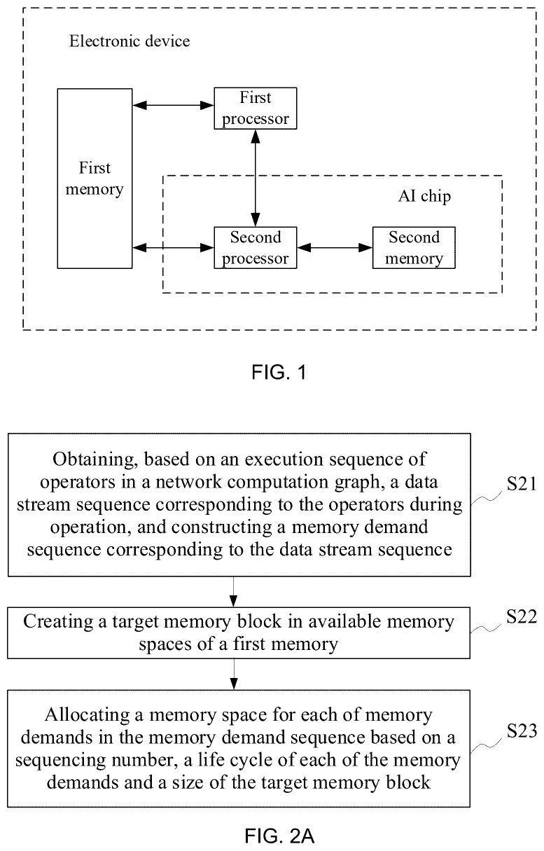

FIG. 1 shows a schematic structural diagram of an electronic device according to an embodiment of the present disclosure. As shown in FIG. 1, the electronic device comprises at least one processor and at least one memory. The processor can be a Central Processing Unit (CPU), Neural-network Processing Unit (NPU), Graphics Processing Unit (GPU), microprocessor, or Application Specific Integrated Circuit (ASIC), among others. The processor is configured to execute various types of instructions and operations, such as running software or firmware programs stored in memory, enabling the device to provide multiple functions and services. For example, the processor can run programs or process data to implement the static memory management method described in the present disclosure.

The memory can be any type suitable for static memory management, such as DDR, SRAM, and more. The memory is used to store program instructions and data, which the processor can call upon to execute the static memory management method.

In some embodiments, the electronic device can be an AI device that comprises an AI chip. The processor may consist of a first processor and a second processor, where the first processor may be external to the AI chip (e.g., a CPU), and the second processor may be internal to the AI chip and comprise registers such as, an NPU. The memory may consist of a first memory and a second memory, where the first memory can be DDR and located outside the AI chip, and the second memory can be SRAM and located inside the AI chip.

The first processor can handle various general computing tasks in the electronic device, such as running the operating system, multitask processing, system management, general data processing, and more.

In some embodiments, the first processor can comprise a driver for the second processor, allowing the first processor to configure the second processor. For instance, the first processor can configure the second processor to process specified data and allocate the registers of the second processor. In some scenarios, images captured by a camera can be automatically stored in a certain memory. Each time an image is stored, the first processor can issue an execution command to the second processor, instructing the second processor to call the image from that memory for AI model inference.

In some embodiments, the second processor can be a neural network processor. The second processor can enable applications like intelligent cognition for smart terminals, including image recognition, face recognition, speech recognition, text understanding, and more. The network code and parameters required during data processing by the second processor can be stored in the second memory.

For illustration purposes, the memory management method provided by the present disclosure is detailed described by taking an AI device and neural network model as examples, along with accompanying drawings. However, it should be understood by those skilled in the art that the memory management method of the present disclosure is applicable to all devices or systems that can adopt static memory management methods.

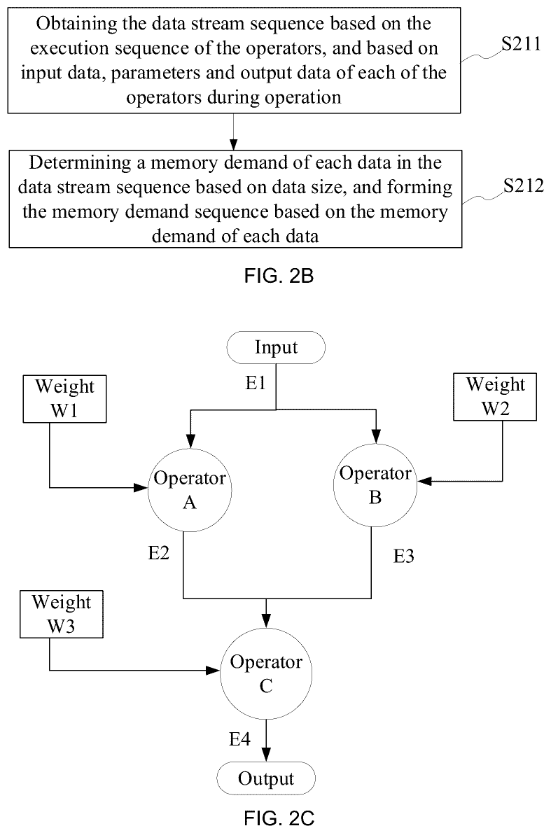

FIG. 2A shows a flowchart of a memory management method according to an embodiment of the present disclosure. As shown in FIG. 2A, the memory management method comprises steps S21-S23.

Step S21 comprises: obtaining, based on an execution sequence of operators in a network computation graph, a data stream sequence corresponding to the operators during operation, and constructing a memory demand sequence corresponding to the data stream sequence.

In some embodiments, the network computation graph is a directed acyclic graph, composed of operators and edges. Each one of the operators corresponds to a computation, such as splitting, convolution, softmax, etc., while the edges represent the data transmission (input/output) relationships between the operators. Before performing calculations on the operators, the operators need to be sorted to determine their execution sequence. Any suitable method can be used to establish this execution sequence.

In some embodiments, referring to FIG. 2B, step S21 comprises steps S211-S212.

Step S211 comprises: obtaining the data stream sequence based on the execution sequence of the operators, and based on input data, parameters and output data of each of the operators during operation.

For example, the execution sequence of the operators in FIG. 2C is assumed to be: Operator A→Operator B→Operator C. When running Operator A, Data E1 and Weight W1 are input into Operator A, and Operator A outputs Data E2; when running Operator B, Data E1 and Weight W2 are input into Operator B, and Operator B outputs Data E3; and when running Operator C, Data E2, Data E3, and Weight W3 are input into Operator C, and Operator C outputs Data E4. Based on the execution sequence of the operators, the data stream sequence is as follows: Data E1, Weight W1, Data E2, Weight W2, Data E3, Weight W3, Data E4.

Step S212 comprises: determining a memory demand of each data in the data stream sequence based on data size, and forming the memory demand sequence based on the memory demand of each data. The sequencing number of each of the memory demands in the memory demand sequence is determined based on a sequencing number of data in the data stream sequence corresponding to each memory demand.

For example, still referring to FIG. 2C, seven memory demands are correspondingly generated based on the data stream sequence, and these memory demands form the memory demand sequence. In the memory demand sequence, the memory demand for Data E1 is placed first, the memory demand for Weight W1 is placed second, . . . , and the memory demand for Data E4 is placed seventh.

In some embodiments, to easily distinguish the sequencing number of each of the memory demands in the memory demand sequence, the memory demands can be labeled based on their sequencing number. For instance, the memory demands for Data E1, Weight W1, Data E2, Weight W2, Data E3, Weight W3, and Data E4 can be labeled as Memory 0, Memory 1, Memory 2, Memory 3, Memory 4, Memory 5, and Memory 6, respectively.

Step S22 comprises: creating a target memory block in available memory spaces of a first memory.

The target memory block (also referred to as memory block) can be a contiguous segment of the available memory spaces within the memory of the electronic device. To accommodate more memory demands, in some embodiments, the target memory block can be the largest contiguous segment of the available memory spaces.

It should be noted that, in FIG. 2B, step S21 is executed first, followed by step S22. However, in practical applications, the execution orders of steps S21 and S22 can be interchangeable; for example, step S22 can be executed first, followed by step S21.

Step S23 comprises: allocating a memory space for each of memory demands in the memory demand sequence based on a sequencing number, a life cycle of each of the memory demands and a size of the target memory block. In some embodiments, the life cycle of each of the memory demands can be obtained through simulation.

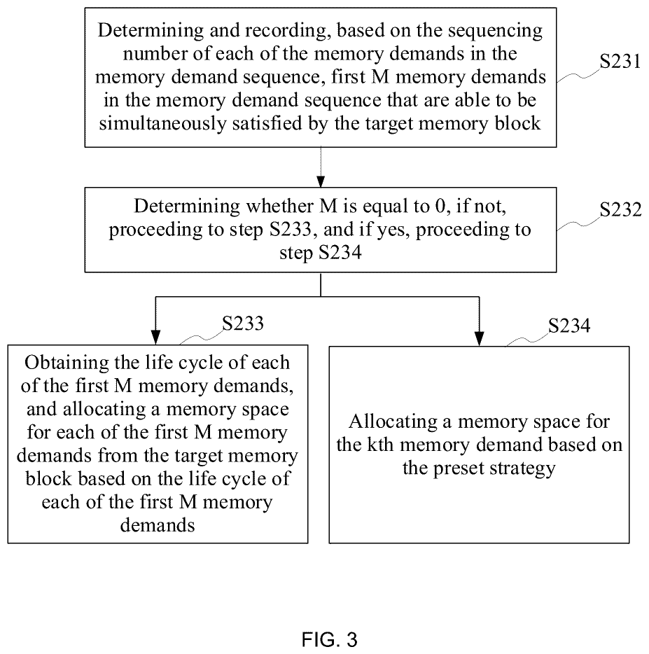

Referring to FIG. 3, specifically, step S23 comprises steps S231-S234.

Step S231 comprises: determining and recording, based on the sequencing number of each of the memory demands in the memory demand sequence, first M memory demands in the memory demand sequence that are able to be simultaneously satisfied by the target memory block, wherein M is an integer less than or equal to N, and N represents a total quantity of the memory demands in the memory demand sequence.

In some embodiments, the first M memory demands can be determined by the following steps a-d.

Step a comprises: denoting a size of a memory space required by a kth memory demand among the memory demand sequence as memory_k_size, and determining whether memory_k_size is less than or equal to a reference comparison value denoted as block_ref_size, where k is a positive integer, initially set to one, and an initial value of the reference comparison value is equal to the size of the target memory block; if so, proceeding to step b, and if not (indicating that available memory spaces of the target memory block cannot meet the kth memory demand), proceeding to step d.

Step b comprises: recording the kth memory demand, and updating the reference comparison value to be block_ref_size-memory_k_size.

Step c comprises: increasing k by 1, and determining whether k is greater than N; if so (indicating that all memory demands have been recorded), ending the process, and if not, returning to step a, until k is greater than N or memory_k_size is greater than block_ref_size.

Step d comprises: determining M as (k−1). It can be understood that all the memory demands recorded in respective steps b constitute the first M memory demands.

In step d, when M is 0, it indicates that the target memory block cannot meet a first memory demand Memory 0 in the memory demand sequence; it means the memory space of the target memory block is too small and must be handled based on a preset strategy, as detailed below.

Step S232 comprises: determining whether M is equal to 0, if not, proceeding to step S233, and if so, proceeding to step S234.

Step S233 comprises: obtaining the life cycle of each of the first M memory demands, and allocating a memory space for each of the first M memory demands from the target memory block based on the life cycle of each of the first M memory demands.

In some embodiments, the life cycle of each of the first M memory demands is obtained based on a dependency relationship between the data corresponding to the memory demands and the sequencing number of each of the memory demands.

In some embodiments, each operator may correspond to multiple memory demands. For example, for Operator A, its Data E1, Weight W1, and Data E2 correspond to memory demands Memory 0, Memory 1, and Memory 2, respectively. Similarly, each memory demand may also correspond to multiple operators. For instance, Data E1 is relevant to both Operator A and Operator B, so Memory 0 for Data E1 applies to both Operator A and Operator B. The life cycle of each memory demand is complete when all its corresponding operators are in a released state. Conversely, the operator is in the released state once all its memory demands have been allocated appropriate memory space. The life cycle of each of the first M memory demands is obtained based on the dependency relationship between the data corresponding to the memory demands and the sequencing number of each of the memory demands.

In some embodiments, a memory space is allocated for each of the first M memory demands along a direction from a first boundary of the target memory block to a second boundary of the target memory block based on a descending order of life cycles of the first M memory demands.

For example, if the address range of the target memory block is [addr_a, addr_b], where addr_a and addr_b are the addresses of the two boundaries of the target memory block. Based on the descending order of the life cycles of the first M memory demands, the memory spaces within the target memory block can be allocated for the memory demands sequentially from addr_a to addr_b, or vice versa.

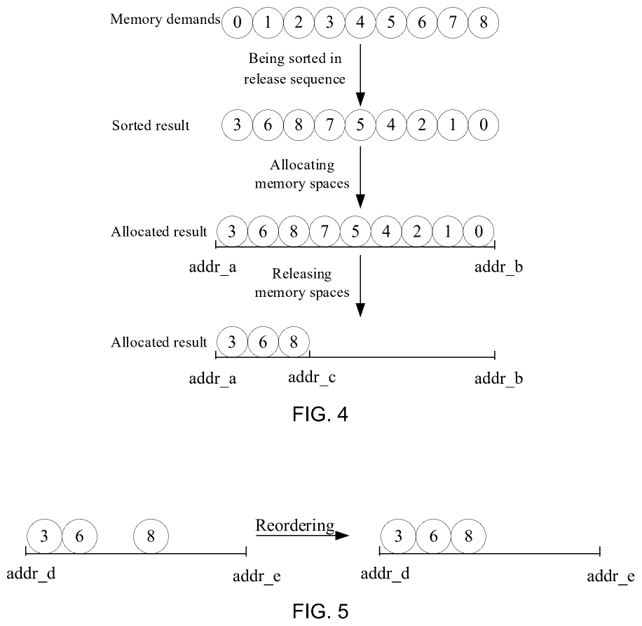

For instance, referring to FIG. 4, the first M memory demands comprises memory demands 0 to 8. The release sequence of these memory demands can be determined based on their lifecycles. In FIG. 4, the memory demands are sorted in release sequence: 0, 1, 2, 4, 5, 7, 8, 6, 3. The life cycle of each of the memory demands can be obtained through simulation. The memory spaces within the target memory block can be allocated for the memory demands sequentially from addr_b to addr_a. Upon release, the closer the memory space is to boundary addr_b, the earlier it is released, reducing memory fragmentation. As shown in FIG. 4, at a certain moment, the memory spaces allocated to memory demands 0, 1, 2, 4, 5, and 7 are released, forming a contiguous segment [addr_c, addr_b].

After step S233, the target memory block can be recreated when the memory demand sequence comprises a memory demand to whom a memory space is yet to be allocated or when a new memory demand sequence is generated. As an example, the released contiguous segment [addr_c, addr_b] can be used as a new target memory block.

Step S234 comprises: allocating a memory space for the kth memory demand based on the preset strategy. It implies that k is initially set to one, meaning the first memory demand in the memory demand sequence is Memory 0.

The preset strategy comprises one or more of reusing the memory spaces, reordering the memory spaces that have been allocated, transferring and releasing part of the memory spaces that have been allocated, and splitting the operators.

### 1. Reusing Memory Space

This approach is suitable for operators whose output can reuse their input memory without affecting the computation results.

Specifically, this approach comprises: searching for a first operator in the operators corresponding to the kth memory demand, wherein the kth memory demand corresponds to output data of the first operator, and a memory space has been allocated to input data of the first operator; when the first operator is found, the memory space allocated to the input data of the first operator can be reused by the kth memory demand; and recreating the target memory block when the reused memory space has been released, and increasing k by 1.

### 2. Reordering Memory Spaces

Specifically, this approach comprises: determining whether a sum of the available memory spaces of the first memory satisfies the kth memory demand, if so, sequentially and continuously arranging the memory spaces that have been allocated from a starting address or an ending address of the first memory by a memory transfer module, thereby increasing the largest contiguous segment of the available memory spaces; allocating a memory space for the kth memory demand from the largest contiguous segment of the available memory spaces; and recreating the target memory block when the memory space of the kth memory demand has been released, and increasing k by 1.

FIG. 5 shows a schematic diagram of reordering the memory spaces according to an embodiment of the present disclosure. As shown in FIG. 5, before reordering, the memory spaces between [addr_d, addr_e] in the memory of device are allocated to memory demands 3, 6, and 8, and the allocated memory spaces are not contiguous. After reordering, the memory spaces allocated to memory demands 3, 6, and 8 become contiguous, thereby increasing the largest contiguous segment of the available memory spaces between [addr_d, addr_e], thus enlarging the target memory block.

### 3. Transferring and Releasing Part of Memory Spaces

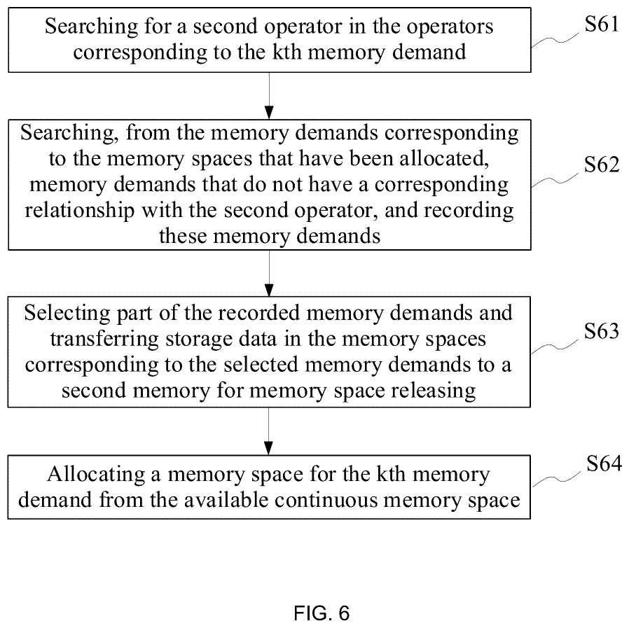

FIG. 6 shows a flowchart of allocating a memory space for the kth memory demand by transferring and releasing part of the memory spaces that have been allocated according to an embodiment of the present disclosure.

Step S61 comprises: searching for a second operator in the operators corresponding to the kth memory demand, where the second operator is the first one found in an UNDEFINED state.

Each operator can correspond to multiple memory demands, and each operator has a corresponding status for each of its memory demands. When none of the memory demands corresponding to the operator have been allocated memory space, the operator's status is UNDEFINED for all its corresponding memory demands. When some of the memory demands corresponding to the operator have been allocated memory space, the operator's status for those allocated demands is RESIDENT. When all the memory demands corresponding to the operator have been allocated memory spaces, the operator's status becomes RELEASED for all its memory demands.

Step S62 comprises: searching, from the memory demands corresponding to the memory spaces that have been allocated, memory demands that do not have a corresponding relationship with the second operator, and recording these memory demands.

Step S63 comprises: selecting part of the recorded memory demands and transferring storage data in the memory spaces corresponding to the selected memory demands to a second memory for memory space releasing. The memory spaces corresponding to the selected memory demands and the available memory spaces in the first memory form an available continuous memory space, and the available continuous memory space is greater than or equal to the memory space required by the kth memory demand.

In some embodiments, when selecting at least a portion of memory demands from the recorded memory demands, the selection may prioritize the portion with the fewest transfer occurrences.

It can be understood that if the previously transferred storage data needs to be transferred again, a memory space can be reallocated for the storage data.

Step S64 comprises: allocating a memory space for the kth memory demand from the available continuous memory space; and recreating the target memory block when the memory space of the kth memory demand has been released, and increasing k by 1.

### 4. Splitting Operators

This approach comprises: searching for a third operator in the operators corresponding to the kth memory demand and splitting the third operator, wherein the kth memory demand corresponds to data of the third operator other than input data, such as output data or parameters; when the third operator is not found, splitting the first operator corresponding to the kth memory demand; after searching for and splitting the third operator, the memory space required by the kth memory demand is reduced, at which time, if the available memory spaces can meet the k memory demand, the memory demand sequence needs to be reconstructed before allocating the memory space for the kth memory demand, as splitting operators change the network computation graph.

In some embodiments, before splitting the operator, the step of transferring, releasing part of the memory spaces that have been allocated and the step of reordering the memory spaces that have been allocated can be implemented first, at which time, the available memory spaces have been maximized, and then the step of operator splitting can be implemented.

If all the above steps and combinations of the steps are exhausted and the memory space required for the k memory demand still cannot be met, it indicates that the available memory spaces are insufficient to meet the operation requirements.

The presently disclosed memory management method reduces data transfer between on-chip and off-chip memory, decreases memory fragmentation, and enhances the utilization of on-chip memory.

The present disclosure further provides a non-transitory computer-readable storage medium, which stores a computer program, and the memory management method as described in the present disclosure is implemented when the computer program is executed by a processor. Those skilled in the art can understand that, all or part of the steps in the method for implementing the above embodiments can be implemented when the computer program is executed by a processor. The non-transitory computer-readable storage medium may be, for example, random access memory, read-only memory, flash memory, hard disk, solid-state disk, magnetic tape, floppy disk, optical disc and any combination thereof. The above storage medium can be any available medium that can be accessed by a computer, or a data storage device that integrates one or more available media, such as a server, a data center, etc. The available medium can be a magnetic medium (such as a floppy disk, a hard disk, or a magnetic tape), an optical medium (such as a digital video disc (DVD)), or a semiconductor medium (such as a solid state disk (SSD)), etc.

The present disclosure further provides an electronic device, comprising a memory and a processor. A computer program is stored on the memory. The processor is communicatively connected to the memory and configured to call the computer program to perform the memory management method of the present disclosure.

The above-mentioned embodiments only exemplarily illustrate the principles and effects of the present disclosure, but are not used to limit the present disclosure. Modifications or variations of the above-described embodiments may be made by those skilled in the art without departing from the spirit and scope of the present disclosure. Therefore, all equivalent modifications or changes made by those who have common knowledge in the art without departing from the spirit and technical concept disclosed by the present disclosure shall be still covered by the claims of the present disclosure.

1. A memory management method, comprising:
S21: obtaining, based on an execution sequence of operators in a network computation graph, a data stream sequence corresponding to the operators during operation, and constructing a memory demand sequence corresponding to the data stream sequence;
S22: creating a target memory block in available memory spaces of a first memory; and
S23: allocating a memory space for each of memory demands in the memory demand sequence based on a sequencing number and a life cycle of each of the memory demands and a size of the target memory block.

2. The memory management method according to claim 1, wherein step S21 is performed by:
obtaining the data stream sequence based on the execution sequence of the operators, and based on input data, parameters and output data of each of the operators during operation; and
determining a memory demand of each data in the data stream sequence based on data size, and forming the memory demand sequence based on the memory demand of each data.

3. The memory management method according to claim 1, wherein the sequencing number of each of the memory demands in the memory demand sequence is determined based on a sequencing number of data in the data stream sequence corresponding to the memory demand.

4. The memory management method according to claim 1, wherein step S23 is performed by:
determining and recording, based on the sequencing number of each of the memory demands in the memory demand sequence, first M memory demands in the memory demand sequence that are able to be simultaneously satisfied by the target memory block, wherein M is an integer less than or equal to N, and N represents a total quantity of the memory demands in the memory demand sequence; and
determining whether M is equal to 0, and if not, obtaining the life cycle of each of the first M memory demands, and allocating a memory space for each of the first M memory demands from the target memory block based on the life cycle of each of the first M memory demands.

5. The memory management method according to claim 4, wherein the first M memory demands in the memory demand sequence that are able to be simultaneously satisfied by the target memory block are determined by:
step a: denoting a size of a memory space required by a kth memory demand among the memory demand sequence as memory_k_size, and determining whether memory_k_size is less than or equal to a reference comparison value denoted as block_ref_size, where k is a positive integer, initially set to one, and an initial value of the reference comparison value is equal to the size of the target memory block,
if yes, proceeding to step b, and
if not, proceeding to step d;
step b: recording the kth memory demand, and updating the reference comparison value to be block_ref_size-memory_k_size;
step c: increasing k by 1, and determining whether k is greater than N,
if yes, ending the process, and
if not, returning to step a, until k is greater than N or memory_k_size is greater than block_ref_size;
step d: determining M as (k−1).

6. The memory management method according to claim 4, wherein obtaining the life cycle of each of the first M memory demands is performed by:
obtaining the life cycle of each of the first M memory demands based on a dependency relationship between the data corresponding to the memory demands and the sequencing number of each of the memory demands.

7. The memory management method according to claim 4, wherein allocating a memory space for each of the first M memory demands from the target memory block based on the life cycle of each of the first M memory demands is performed by:
allocating, based on a descending order of life cycles of the first M memory demands, a memory space for each of the first M memory demands along a direction from a first boundary of the target memory block to a second boundary of the target memory block.

8. The memory management method according to claim 4, wherein after allocating a memory space for each of the first M memory demands from the target memory block, the memory management method further comprises:
recreating the target memory block when the memory demand sequence comprises a memory demand to whom a memory space is yet to be allocated or a new memory demand sequence is generated.

9. The memory management method according to claim 4, wherein when M is equal to 0, the memory management method further comprises: allocating a memory space for a first memory demand among the memory demand sequence based on a preset strategy.

10. The memory management method according to claim 9, wherein the preset strategy comprises one or more of reusing the memory spaces, reordering the memory spaces that have been allocated, transferring and releasing part of the memory spaces that have been allocated, and splitting the operators.

11. The memory management method according to claim 10, wherein allocating a memory space for the first memory demand by reusing the memory spaces comprises:
searching for a first operator in the operators corresponding to the first memory demand, wherein the first memory demand corresponds to output data of the first operator, and a memory space has been allocated to input data of the first operator; and
when the first operator is found, reusing the memory space allocated to the input data of the first operator for the first memory demand.

12. The memory management method according to claim 10, wherein allocating a memory space for the first memory demand by reordering the memory spaces that have been allocated comprises:
determining whether a sum of the available memory spaces of the first memory satisfies the first memory demand,
if yes, configuring a memory transferring module to sequentially and continuously arrange the memory spaces that have been allocated from a starting address or an ending address of the first memory, and
allocating a memory space for the first memory demand from the remaining available memory spaces of the first memory after the arranging of the memory spaces that have been allocated is completed.

13. The memory management method according to claim 10, wherein allocating a memory space for the first memory demand by transferring and releasing part of the memory spaces that have been allocated comprises:
searching for a second operator in the operators corresponding to the first memory demand, where the second operator is the first one found in an undefined state, and the undefined state indicates that none of the memory demands corresponding to the second operator have been allocated a memory space;
searching, from the memory demands corresponding to the memory spaces that have been allocated, memory demands that do not have a corresponding relationship with the second operator, and recording the memory demands;
selecting part of the recorded memory demands and transferring storage data in the memory spaces corresponding to the selected memory demands to a second memory for memory space releasing, wherein the memory spaces corresponding to the selected memory demands and the available memory spaces in the first memory form an available continuous memory space, and the available continuous memory space is greater than or equal to the memory space required by the first memory demand; and
allocating a memory space for the first memory demand from the available continuous memory space.

14. The memory management method according to claim 10, wherein allocating a memory space for the first memory demand by splitting the operators comprises:
searching for a third operator in the operators corresponding to the first memory demand and splitting the third operator, wherein the first memory demand corresponds to data of the third operator other than input data; and
after searching for and splitting the third operator, determining whether a sum of the available memory spaces of the first memory satisfies the first memory demand, and if yes, reconstructing the memory demand sequence and allocating a memory space for the first memory demand.

15. The memory management method according to claim 1, wherein the network computation graph is a directed acyclic graph.

16. The memory management method according to claim 1, wherein the target memory block is a continuous memory space in the available memory spaces of the first memory.

17. A non-transitory computer-readable storage medium, which stores a computer program, wherein the memory management method according to claim 1 is implemented when the computer program is executed by a processor.

18. An electronic device, comprising:
a memory, on which a computer program is stored; and
a processor, communicatively connected to the memory and configured to call the computer program to perform the memory management method according to claim 1.
